(19) United States
(12) Patent Application Publication
(10) Pub. No.: US 2014/0231230 A1
(43) Pub. Date: Aug. 21, 2014

(54) SHORT-CIRCUITING SWITCH OF AN ELECTRICAL ENERGY PRODUCTION INSTALLATION

(71) Applicants: Franck Sarrus, Saint Laurent de Mure (FR); Thierry Rambaud, Genas (FR); Jean-Luc Birant, Villeurbanne (FR)

(72) Inventors: Franck Sarrus, Saint Laurent de Mure (FR); Thierry Rambaud, Genas (FR); Jean-Luc Birant, Villeurbanne (FR)

(73) Assignee: MERSEN FRANCE SB SAS, Saint-Bonnet-De-Mure (FR)

(21) Appl. No.: 13/824,921

(22) PCT Filed: Jun. 15, 2012
(86) PCT No.: PCT/EP12/61521

§ 371 Date: Apr. 25, 2013

(30) Foreign Application Priority Data
Jun. 15, 2011 (FR) 1155205

(51) Int. Cl. H01H 19/40

(52) U.S. Cl. CPC H01H 19/40
USPC 200/2

(57) ABSTRACT

A short-circuiting switch for an electrical energy production installation is provided. The short-circuiting switch comprising at least one photovoltaic panel is adapted for simultaneously establishing a short-circuit at the installation ends and a short-circuit at the ends of an electrical network connected to the installation ends. It comprises an element, mobile in rotation about an axis between a first position, in which two conducting tracks of the mobile element which are distinct conduct the current between, on one hand, a first terminal connected to the installation and a first terminal connected to the network, and, on the other hand, a second terminal connected to the installation and a second terminal connected to the network, and a second position in which the mobile element simultaneously establishes and maintains the short-circuit at the ends of the installation and at the ends of the network and electrically isolates the installation from the network.

The invention relates to a short-circuiting switch for an electrical energy production installation in particular comprising photovoltaic panels.

In the field of electrical energy production through the recovery of solar radiation, it is known to equip the buildings on which photovoltaic panels are installed with short-circuiting switches making it possible to short-circuit the photovoltaic installation, to ensure the safety of individuals in the event of maintenance or emergency operations in the building.

Short-circuiting switches as known from EP-1,720,241 make it possible to simultaneously short-circuit the terminals of the photovoltaic installation and the terminals of the network to which the photovoltaic installation is connected. Such devices for example implement electronic components capable of connecting the terminals of the installation to each other.

The known techniques use electronic components that may be subject to malfunctions or destruction.

The invention aims to resolve these drawbacks by proposing a new short-circuiting switch, the operation of which is safer than the short-circuiting switches of the state of the art.

To that end, the invention relates to a short-circuiting switch for an electrical energy production installation comprising at least one photovoltaic panel, which is adapted for simultaneously establishing a short-circuit at the ends of the installation and a short-circuit at the ends of an electrical network connected to the ends of the installation. The short-circuiting switch is characterized in that it comprises an element, mobile in rotation around an axis between a first position, in which two conducting tracks of the mobile element which are distinct conduct the current between, on the one hand, a first terminal connected to the installation and a first terminal connected to the network, and, on the other hand, a second terminal connected to the installation and a second terminal connected to the network, and a second position in which the mobile element simultaneously establishes and maintains the short-circuit at the ends of the installation and at the ends of the network and electrically isolates the installation from the network.

Owing to the invention, the short-circuit is established owing to the movement of a mechanical part without using electronic components, which procures improved reliability relative to the short-circuiting switches of the state of the art.

According to advantageous but optional aspects of the invention, such a short-circuiting switch may incorporate one or more of the following features, considered in any technically allowable combination:

The conducting tracks of the mobile elements extend over two substantially opposite portions of a cylindrical peripheral surface of the mobile element centered on the axis of rotation of the mobile element, and in that the conducting tracks of the mobile element are stepped along the axis of rotation of the mobile element.

The terminals are stepped across from the conducting tracks of the mobile element such that, when the mobile element goes from its first position to its second position, the electrical connection between the installation and the network is interrupted only if the electrical connection between the ends of the installation is established.

When the mobile element is in its first position, the conducting tracks are positioned such that, when the mobile element goes from its first to its second position, the short-circuit at the ends of the installation is established first, the short-circuit at the ends of the network is established second, and the isolation of the installation relative to the network is established last.

When the mobile element is in its first position, a first angle defined between, on the one hand, a first interface between a first track and an isolating quantity and, on the other hand, a radius extending from the axis of rotation and passing through a point of contact between the rotating element and a terminal connected to the network is larger than a second angle defined between, on the one hand, a second interface between the first track and the isolating quantity and, on the other hand, a radius extending from the axis of rotation and passing through a point of contact between the rotating element and a terminal connected to the installation and diametrically opposite the terminal connected to the network, and a third angle defined between, on the one hand, a third interface between a second track and the isolating quantity and, on the other hand, the radius extending from the axis of rotation and passing through the point of contact between the rotating element and the terminal connected to the installation is larger than a fourth angle defined between, on the one hand, a fourth interface between the second track and the isolating quantity and, on the other hand, the radius extending from the axis of rotation and passing through the point of contact between the rotating element and the terminal connected to the network, and the third angle is larger than the second angle, and the first angle is larger than the fourth angle.

The terminals connected to the installation and a first terminal connected to the network are adapted to be in simultaneous electrical contact with a first conducting track of the mobile element, while the terminals connected to the network and a terminal connected to the installation and diametrically opposite the first terminal connected to the network relative to the mobile element, are adapted to be in simultaneous electrical contact with the second conducting track of the mobile element.

The conducting tracks extend over angular sectors with apical angles larger than 180°.

The member capable of activating signaling comprises a part protruding from an outer surface of the mobile element and adapted to strike a pivoting lever that keeps a signaling element in a retracted position.

In the first position of the mobile element, the protruding part is angularly offset relative to the pivoting lever such that the visual signal is activated after the cutoff is established between the ends of the installation and the ends of the network.

The mobile element includes a member capable of activating a signal when the short-circuit is established at the ends of the installation and at the ends of the network, and the installation is electrically isolated from the network.

The short-circuiting switch includes a return member tending to drive the mobile element toward its second position, while the mobile element is kept in its first position, against the action of the return member, by a strike that cooperates with a stop of the moving element.

The return member is a spiral spring wound in a cylindrical housing of the mobile element.

The short-circuiting switch includes a rearming device making it possible to return the mobile element to its first position.

The invention will be better understood, and other advantages thereof will appear more clearly, in light of the following description of a short-circuiting switch according to its principle, provided solely as an example and done in reference to the appended drawings, in which:

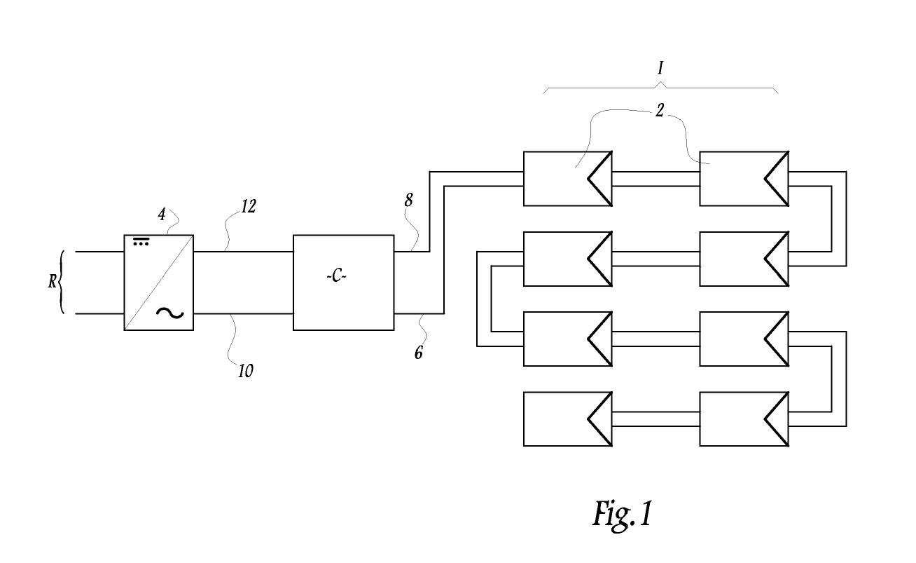

FIG. 1 is a block diagram of a photovoltaic installation comprising a short-circuiting switch according to the invention;

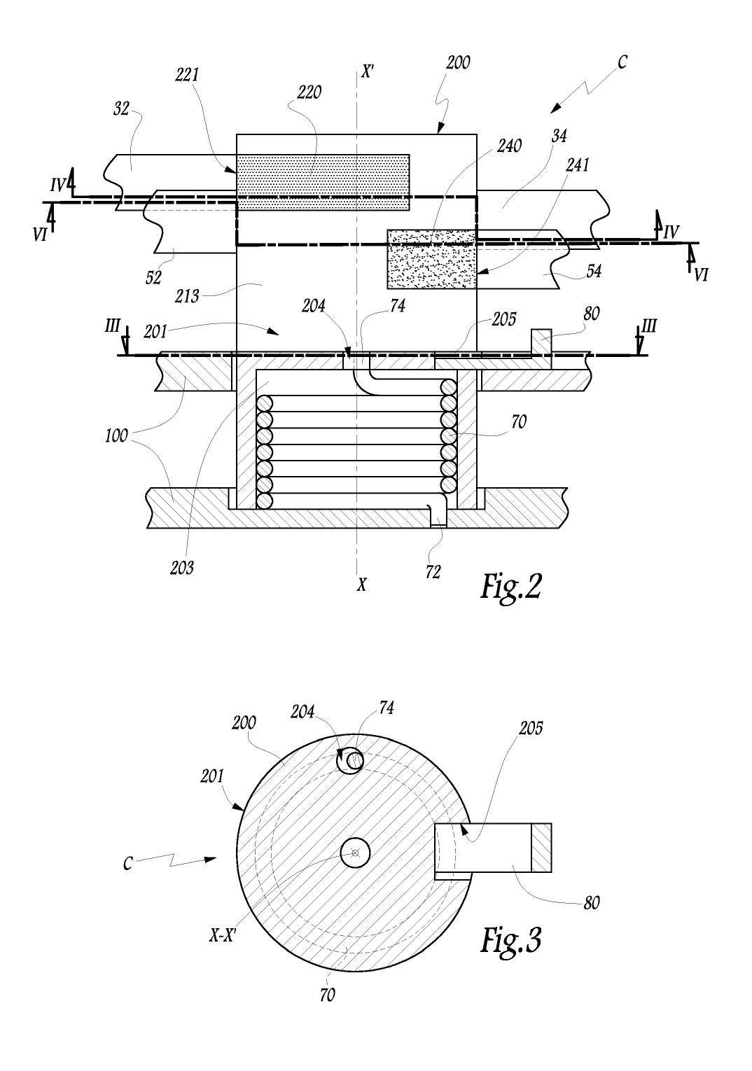

FIG. 2 is a side view of the short-circuiting switch according to the invention where the drum is shown in cross-section at the bottom part of the figure;

FIG. 3 is a cross-sectional view of the short-circuiting switch along plane III in FIG. 2;

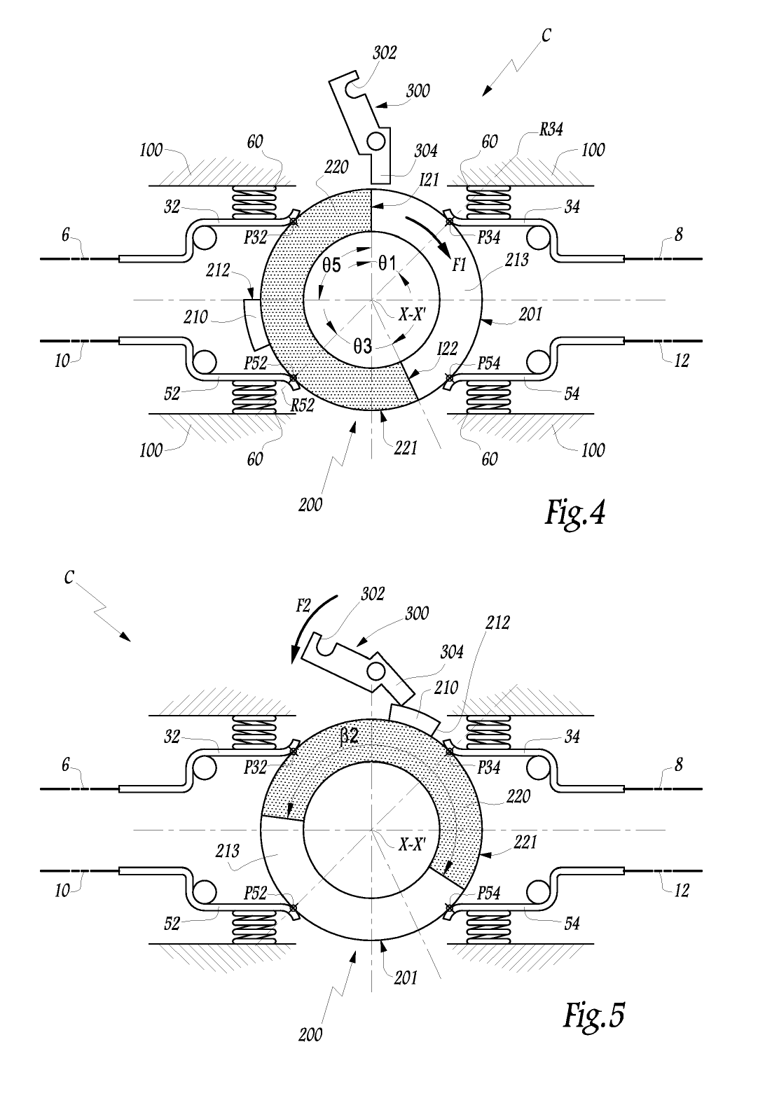

FIG. 4 is a cross-sectional view of the short-circuiting switch along plane IV of FIG. 2, the short-circuiting switch being in a first configuration;

FIG. 5 is a cross-section similar to FIG. 4, when the short-circuiting switch is in a second configuration;

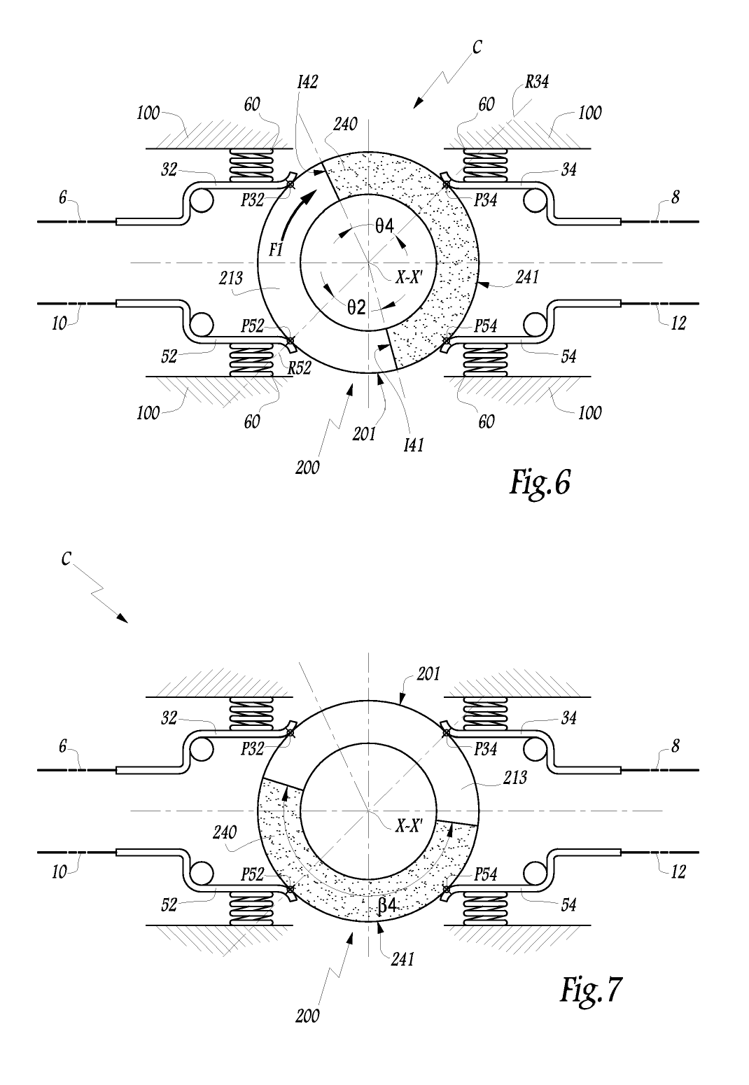

FIG. 6 is a cross-action of the short-circuiting switch along plane VI in FIG. 2, when the short-circuiting switch is in the first configuration;

FIG. 7 is a cross-section similar to FIG. 6, when the short-circuiting switch is in the second configuration.

The photovoltaic invention I shown in FIG. 1 includes a plurality of photovoltaic panels 2 connected to each other serially or in parallel. The installation I produces energy from solar radiation and supplies that energy to a network R. Connected between the installation I and the network R are a short-circuiting switch C and an inverter 4 suitable for converting the DC current withdrawn by the installation I into AC current usable by electrical equipment, not shown, connected to the network R and, if applicable, used in the building in which the installation I is implemented.

The arrival of the current in the short-circuiting switch C occurs through two cables or ends 6 and 8 provided with terminals, not shown, to which the short-circuiting switch C is connected. At the output of the short-circuiting switch C, two cables 10 and 12 convey the current to the inverter 4. Hereafter, these cables 10 and 12 will be considered to be the ends of the network R.

The short-circuiting switch C is adapted so as, if needed, i.e., in the event of an operation by firefighters with respect to an accident in the building or maintenance operation by qualified personnel, to secure the building by deactivating the electrical production of the installation I. To that end, the short-circuiting switch C is suitable for short-circuiting the installation I as close as possible to the photovoltaic panels, and simultaneously short-circuiting the ends of the network R.

The short-circuiting switch includes two electrically conducting terminals 32 and 34 connected to the ends 6 and 8 of the installation I and two electrically conducting terminals 52 and 54 connected to the ends 10 and 12 of the network R. These connections may, for example, be done by a screw gripping the cables of the network in clamps or using any other suitable means. In the example, the terminals 32, 34, 52 and 54 are respectively connected to the cables 6, 8, 10 and 12, as shown diagrammatically in FIGS. 4 to 7.

The terminals 32, 34, 52 and 54 may be strips of a conducting material such as copper.

The conducting terminals 32, 34, 52 and 54 are mounted on a housing 100 of the short-circuiting switch.

The short-circuiting switch C includes a mobile element or drum 200 mounted in the housing 100 with the possibility of pivoting relative to the housing 100 around an axis of rotation X-X′ corresponding to the axis of symmetry of the outer peripheral surface 201 of the drum 200.

The drum 200 has a generally cylindrical shape with a circular cross-section. The drum 200 includes two conducting tracks 220 and 240 integrated into the drum 200. The tracks 220 and 240 consist of segments of rings made from a conducting material such as copper and whereof the respective outer peripheral surfaces 221 and 241 are flush on two substantially opposite portions of the outer cylindrical surface 201 of the drum 200. The conducting tracks 220 and 240 are stepped along the axis X-X′ and are driven into a mass 213 of isolating material. The track 220 has, at its ends, two interfaces I21 and I22 with the installation of the drum 200. The track 240 has, at its ends, two interfaces I41 and I42 with the installation of the drum 200.

The tracks 220 and 244 are suitable for being in electrical contact with the terminals 32, 34, 52 and 54. To that end, each of the terminals 32, 34, 52 and 54 is kept in contact with the tracks 220 and/or 240 by a spring 60 inserted between the terminal and the housing 100, or using any other suitable elastic return means. The springs 60 make it possible to ensure contact pressure adapted to the current to be conveyed. In a first configuration of the short-circuiting switch C, the drum 200 is in a first position where it allows the electrical current to circulate from the installation I to the network R. This corresponds to the configuration of FIGS. 4 and 6, in which the terminals 32 and 52, on the one hand, and the terminals 34 and 54, on the other hand, are respectively electrically connected by means of the tracks 220 and 240 of the drum 200.

The drum 200 includes a cylindrical housing 203 in which a spiral spring 70 is wound that tends to rotate the drum 200 around the axis X-X′, from the first current-conducting position, and in the direction of arrow F1 in FIGS. 4 and 6. The drum 200 is kept in its first position by a strike 80 that cooperates with a stop 205 of the drum 200. The action of the strike 80 opposes the torque of the spring 70, which is exerted between the housing 100 and the drum 200. The spring 70 includes an end 72 that is stationary relative to the housing 100, and an end 74 that is secured to the drum 200 and inserted in a hole 204 that is off-centered relative to the axis X-X′. When the drum 200 is in its first position, the short-circuiting switch is in a first so-called on configuration, where it connects the panels 2 to the network R. More specifically, the cables 6 and 10 are connected by the terminals 32 and 52 and the track 220, whereas the cables 8 and 12 are connected by the terminals 34 and 54 and the track 240.

In the event a security or maintenance operation must occur in the building, the short-circuit is activated by the operating personnel, using suitable local or remote control means (not shown), for example of the pneumatic, mechanical, electrical, pyrotechnic, or any other type. The strike 80 is released from the stop 205, which results in eliminating the resistance to the torque of the spiral spring 70, and allowing the drum 200 to rotate from its first current-conducting position to its second short-circuit position shown in FIGS. 5 and 7. When the drum 200 is in its second position, the short-circuiting switch C is in a so-called “cutoff” configuration, where it isolates the panels 2 from the network R.

In this second configuration, the cables 6 and 8 are electrically connected by the terminals 32 and 34 and the track 220. The panels 2 are thus in short-circuit. Furthermore, the cables 10 and 12 are connected by the terminals 52 and 54 and the track 240. The network R is thus in short-circuit.

The distribution of the terminals 32, 34, 52 and 54 around the drum 200 is regular, the respective point of contact P32, P34, P52 and P54 of each of these terminals with the drum 200 being separated from the point of contact of the two adjacent terminals by a 90° angle. A rotation of the drum 200 around the axis X-X′ from its first position must therefore be at least equal to 90° for the terminals 32 and 34 to be electrically connected together and for the terminals 52 and 54 to be electrically connected together.

In order to avoid electric arcs that may be dangerous for the installation I and for people in the immediate vicinity of the short-circuiting switch C, it is necessary for the electrical current in the circuit connecting the installation I and the network R not to be interrupted when the drum goes from its first position to its second position. This is therefore necessary to ensure that the electrical contact between the terminals 32 and 34, on the one hand, and the electrical contact between the terminals 52 and 54, on the other hand, are well-established before eliminating the contact between the terminals 32 and 52 and the terminals 34 and 54.

The angle of rotation θ1 necessary to establish electrical contact between the terminals 32 and 34 from the first position of the drum 200 is set at 45°. This value is non-limiting. In fact, this value may be different and serves as a basis for determining the angles of rotation that are necessary to establish electrical connections between the terminals 32, 34, 52 and 54 depending on the desired order of establishment of the electrical connections.

As shown in FIG. 4, in the first position of the drum 200, the interface I21 between the conducting track 220 and the isolating material is angularly offset, relative to a radius R34 extending from the axis X-X′ and passing through the point of contact P34, from the angle θ1. When the rotational movement of the drum 200 continues, electrical contact is produced between the terminals 52 and 54 owing to the rotation of the track 240. For this contact to occur after the terminals 32 and 34 are put in contact, in the first position of the drum 200, the interface I41 between the tracks 240 and the isolating material is offset, relative to a radius R52 extending from the axis X-X′ and passing through the point of contact P52, by an angle θ2 with a larger value than that of the angle θ1, for example equal to 60°.

For the electrical contacts between the terminals 32 and 34 and between the terminals 52 and 54 to be done before breaking the contacts between tracks 32 and 52 and between the terminals 34 and 54, it is necessary for the tracks 220 and 240 simultaneously to put three terminals in contact, during a transitional step between the first and second configurations of the short-circuiting switch C. For that reason, the angular sectors over which the tracks 220 and 240 extend have respective apical angles β2 and β4 larger than 180°. This involves stepping the tracks 220 and 240 along the axis X-X′. The terminals 32, 34, 52 and 54 are also stepped along the axis X-X′ such that the terminals 32, 34 and 52 can be in simultaneous electrical contact with the track 220, and such that the terminals 34, 52 and 54 can be in simultaneous electrical contact with the track 240. The terminals 32 and 54, which are diametrically opposite relative to the drum 200, are only in contact with the track 220 and the track 240, respectively, and therefore have no coinciding part along the axis X-X′.

Once the drum 200 is rotated from its first position by an angle equal to θ2, the electrical contact is established between the terminals 32 and 34 and between the terminals 52 and 54. As a result, it is possible to interrupt the electrical connection between the terminals 32 and 52 and between the terminals 34 and 54 without causing electric arcs. In the first position of the drum 200, the interface I22 between the track 220 and the isolating material forms an angle θ3 with the radius R52. Similarly, in the first position of the drum 200, the interface I42 between the track 240 and the isolating material forms an angle θ4 with the radius R34. The angles θ3 and θ4 have a value larger than that of the angle θ2, for example equal to 70°. When the angle of rotation of the drum 200 from its first position reaches the value of θ3 or θ4, the respective electrical contacts between the track 220 and the terminal 52 and between the track 240 and the terminal 34 are interrupted, and the cables 10 and 12 are isolated from the cables 6 and 8.

In order to indicate to the people operating in the building that the securing has been done and that the people in question can enter the building risk-free, a visual signal, for example positioned on the roof of the building so as to be visible from below, is activated once the short-circuit is established. The drum 200 to that end includes an activating member 210 in the form of a part protruding from the outer surface 201. This protruding part is adapted so as, during rotation of the drum, to strike a pivoting lever 300 that keeps a visual signaling element (not shown) in a retracted position, owing to a notch 302. The signaling element may, for example, be an object in a bright color or covered with a reflective material that is subject to the action of a return spring toward a signaling position indicating securing of the installation. In that case, the pivoting lever 300 releases that object when it pivots under the action of the member 210, in the direction of arrow F2 in FIG. 5.

Since the activation of this visual signal must be done only after the short-circuits and cutoffs are established, the drum 200 must be rotated relative to its first position by an angle larger than the angle of rotation necessary to establish the short-circuits and the cutoffs. The activating member 210 includes a striking face 212 which, in the first position of the drum 200, is angularly offset relative to a rod 304 of the pivoting lever 300, by an angle θ5 whereof the value is larger than that of the angles θ3 and θ4. In the illustrated example, the angle θ5 is equal to 90°. The rotation of the drum 200 therefore continues once the angles θ3 and θ4 have been reached. This not only makes it possible to ensure that the contact between the terminals and the tracks of the drum occurs at a certain distance from the ends of the conducting tracks, but also to ensure that the visual signal is only activated after the actual establishment of the cutoff between the ends of the installation I and the ends of the network R.

Once the drum 200 is in its second position, it is kept in that position by the spring 70. Means for stopping the rotation (not shown) make it possible to stop drum 200 at the desired orientation. An outside operation is then necessary to reestablish the normal passage of the current, such that the short-circuit between the cables 6 and 8, on the one hand, and the cables 10 and 12, on the other hand, and the cutoffs between the cables 6 and 10, on the one hand, and the cables 8 and 12, on the other hand, are automatically maintained once established.

Alternatively, the angles θ1, θ2, θ3, θ5 and θ5 may have different values from the aforementioned values. The values of the angles θ3 and θ4 may also be different, such that the interruption of the electrical contact between the terminals 32 and 52 and between the terminals 34 and 54 may occur non-simultaneously. It may also be considered for the angles θ1 and θ2 to have an equal value so that the establishment of electrical contact of the terminals 32 and 34 and the terminals 52 and 54 is simultaneous.

According to alternatives not shown, the system for keeping the drum 200 in its first position against the torque of the spring 70 is done differently. Likewise, the activation mode for the visual signal may be different.

According to one embodiment not shown, the short-circuiting switch C includes a rearming device making it possible to return the drum 200 to its first position once the operation in the building is complete and the electrical production of the installation I can be reactivated.

1. A short-circuiting switch for an electrical energy production installation comprising at least one photovoltaic panel, which is configured to simultaneously establish a short-circuit at ends of the installation and a short-circuit at ends of an electrical network connected to the ends of the installation,
wherein the switch comprises an element, mobile in rotation around an axis between a first position, in which two conducting tracks of the mobile element which are distinct conduct the current between, on the one hand, a first terminal connected to the installation and a first terminal connected to the network, and, on the other hand, a second terminal connected to the installation and a second terminal connected to the network, and a second position in which the mobile element simultaneously establishes and maintains the short-circuit at the ends of the installation and at the ends of the network and electrically isolates the installation from the network.

2. The short-circuiting switch according to claim 1, wherein the conducting tracks of the mobile elements extend over two substantially opposite portions of a cylindrical peripheral surface of the mobile element centered on the axis of rotation of the mobile element, and wherein the conducting tracks of the mobile element are stepped along the axis of rotation of the mobile element.

3. The short-circuiting switch according to claim 2, wherein the terminals are stepped across from the conducting tracks of the mobile element such that, when the mobile element goes from its first position to its second position, the electrical connection between the installation and the network is interrupted only if the electrical connection between the ends of the installation is established.

4. The short-circuiting switch according to claim 1, wherein, when the mobile element is in its first position, the conducting tracks are positioned such that, when the mobile element goes from its first to its second position, the short-circuit at the ends of the installation is established first, the short-circuit at the ends of the network is established second, and the isolation of the installation relative to the network is established last.

5. The short-circuiting switch according to claim 4, wherein when the mobile element is in its first position,
a first angle defined between, on the one hand, a first interface between a first track and an isolating quantity and, on the other hand, a radius extending from the axis of rotation and passing through a point of contact between the rotating element and a terminal connected to the network, is larger than a second angle defined between, on the one hand, a second interface between the first track and the isolating quantity and, on the other hand, a radius extending from the axis of rotation and passing through a point of contact between the rotating element and a terminal connected to the installation and diametrically opposite the terminal connected to the network, and
a third angle defined between, on the one hand, a third interface between a second track and the isolating quantity and, on the other hand, the radius extending from the axis of rotation and passing through the point of contact between the rotating element and the terminal connected to the installation is larger than a fourth angle defined between, on the one hand, a fourth interface between the second track and the isolating quantity and, on the other hand, the radius extending from the axis of rotation and passing through the point of contact between the rotating element and the terminal connected to the network, and
the third angle is larger than the second angle, and
the first angle is larger than the fourth angle.

6. The short-circuiting switch according to claim 5, wherein the terminals connected to the installation and a first terminal connected to the network are adapted to be in simultaneous electrical contact with a first conducting track of the mobile element, and wherein the terminals connected to the network and a terminal connected to the installation and diametrically opposite the first terminal connected to the network relative to the mobile element, are adapted to be in simultaneous electrical contact with the second conducting track of the mobile element.

7. The short-circuiting switch according to claim 6, wherein the conducting tracks extend over angular sectors with apical angles larger than 180°.

8. The short-circuiting switch according to claim 1, wherein the mobile element includes a member capable of activating a signal when the short-circuit is established at the ends of the installation and at the ends of the network and the installation is electrically isolated from the network.

9. The short-circuiting switch according to claim 8, wherein the member capable of activating signaling comprises a part protruding from an outer surface of the mobile element and adapted to strike a pivoting lever that keeps a signaling element in a retracted position.

10. The short-circuiting switch according to claim 9, wherein in the first position of the mobile element, the protruding part is angularly offset relative to the pivoting lever such that the visual signal is activated after the cutoff is established between the ends of the installation and the ends of the network.

11. The short-circuiting switch according to claim 1, wherein it includes a return member tending to drive the mobile element toward its second position, and wherein the mobile element is kept in its first position, against the action of the return member, by a strike that cooperates with a stop of the moving element.

12. The short-circuiting switch according to claim 1, wherein the return member is a spiral spring wound in a cylindrical housing of the mobile element.

13. The short-circuiting switch according to claim 1, wherein the short-circuiting switch includes a rearming device making it possible to return the mobile element to its first position.
